(19) United States
(12) Patent Application Publication
(10) Pub. No.: US 2024/0083228 A1
(43) Pub. Date: Mar. 14, 2024

(54) Vehicle Cover Assembly

(71) Applicants: Merav Aharon Serok, Kfar Sava (IL); Ohad Serok, Kfar Sava (IL)

(72) Inventors: Merav Aharon Serok, Kfar Sava (IL); Ohad Serok, Kfar Sava (IL)

(21) Appl. No.: 18/244,954

(22) Filed: Sep. 12, 2023

Related U.S. Application Data
(60) Provisional application No. 63/406,242, filed on Sep. 13, 2022.

(51) Int. Cl. B60J 11/04

(52) U.S. Cl. CPC B60J 11/04

(57) ABSTRACT

A vehicle cover assembly including a vehicle cover a carrying bag. The vehicle cover has at least one panel. The vehicle cover includes a multi-layered fabric. The at least one panel includes at least one flexible rod removably attached to the vehicle cover.

### RELATED APPLICATIONS

This application claims the benefit under 35 U.S.C. 119(e) of U.S. Provisional Patent Application No. 63/406,242, filed on Sep. 13, 2022, the entirety of which is incorporated by reference.

### BACKGROUND OF THE INVENTION

Vehicle covers are typically used to protect a car from physical damage to the exterior of the vehicle, for example a car, and provide cover from extreme temperatures. Vehicle covers are important to vehicle owners as it serves as the first line of defense against environmental issues that may impact the physical integrity of their vehicle. Many vehicle covers are sized to fit the general width and length of a particular vehicle, i.e. car covers are sized to fit the general length and width of a standard size car. In fact, most current car covers are simply large, amorphous, tarps that sit on top of vehicles. The typical vehicle cover does not have a structured shape to conform to the curvature of the vehicle, nor are they made from materials that are best suited for easy application and removal. These covers do not allow for proper fit, or proper airflow around the vehicles. Typical vehicle covers are large and cumbersome to apply over the vehicle, difficult to store in a compact manner, and difficult to remove.

Most vehicle covers can reduce the amount of air flow around a vehicle. This can cause overheating of the vehicle in a way that can be detrimental to the vehicle's internal system. This is particularly problematic for modern vehicles that are becoming increasingly made with a significant number of computerized parts. A properly fitted vehicle cover can reduce the likely hood of overheating the mechanical and computerized components of any vehicle.

There is a need for vehicle covers with better secure fit around the vehicle while allowing for improved airflow around the vehicle. There is also a need for car covers to be easily applied, removed, and stored.

### SUMMARY OF THE INVENTION

Aspects of the disclosure relate to methods and apparatuses relating to a vehicle cover assembly including a vehicle cover and a carrying bag. The vehicle cover has at least one panel. The vehicle cover includes a multi-layered fabric. The at least one panel includes at least one flexible rod removably attached to the vehicle cover.

Aspects of the disclosure further relates to a vehicle cover assembly including a vehicle cover a carrying bag. The vehicle cover has at least one panel. The vehicle cover includes a multi-coated fabric. The at least one panel includes at least one flexible rod removably attached to the vehicle cover.

Aspects of the disclosure further relate to a method of using a vehicle cover assembly. The method comprises providing a vehicle cover assembly. the vehicle cover includes a vehicle cover having at least one panel, wherein the at least one panel includes at least one flexible rod removably attached to the vehicle cover; and a carrying bag. The method further includes unfolding the vehicle cover. The method further includes placing the vehicle cover over a vehicle. The method further includes securing the vehicle cover to the vehicle by attaching a first and second side elastic band, a rear elastic band, and a front elastic band to the vehicle.

These and other aspects of the disclosure will be described in greater detail below.

### BRIEF DESCRIPTION OF THE DRAWINGS

The present disclosure is illustrated by way of example and not limited in the accompanying figures in which like reference numerals indicate similar elements and in which:

FIG. 1 illustrates a top view of a vehicle cover covering a vehicle,

FIG. 2 illustrates an expanded view of a first embodiment of a vehicle cover,

FIG. 3 illustrates an expanded view of a second embodiment of a vehicle cover,

FIG. 4 illustrates a sectional view of a panel of the vehicle cover,

FIG. 5a illustrates a sectional view of a flexible rod,

FIG. 5b illustrates a sectional view of the flexible rod inserted into a pocket of a frame,

FIG. 5c illustrates a sectional view of a first end of the flexible rod being attached to a second end of the flexible rod,

FIG. 5d illustrates a sectional view of the flexible rod being inserted into the frame of a panel,

FIG. 6 illustrates a front view of a vehicle cover,

FIG. 7 illustrates a back view of the vehicle cover,

FIG. 8 illustrates a side view of the vehicle cover,

FIG. 9 illustrates a side view of a side mirror band;

FIG. 10 illustrates a side view of an anti-theft anchor;

FIG. 11 illustrates a perspective view of a first embodiment of a carrying bag,

FIG. 12 illustrates a second embodiment of a carrying bag,

FIG. 13 illustrates a third embodiment of the vehicle cover,

FIG. 14 illustrates a fourth embodiment of the vehicle cover,

FIG. 15 illustrates a fifth embodiment of the vehicle cover,

FIG. 16 illustrates a sixth embodiment of the vehicle cover, and

FIG. 17 illustrates a seventh embodiment of the vehicle cover.

### DETAILED DESCRIPTION OF THE DRAWINGS

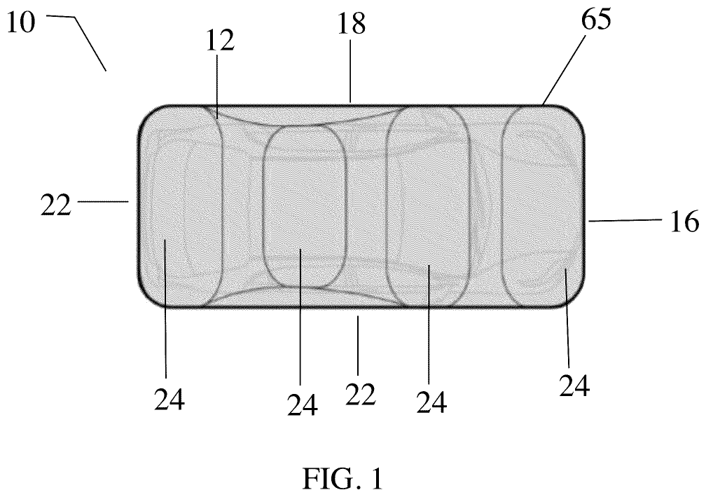

Referring to FIG. 1, the present disclosure relates to a vehicle cover assembly 10. The vehicle cover assembly 10 includes a vehicle cover 12 and a carrying bag 13. The vehicle cover 12 covers at least a front end 16, a first and second side 18, 20, and a back end 22 of a vehicle 14. Additionally, the vehicle cover 12 is sized according a particular motorized vehicles on which the vehicle cover 12 is used, including, but not limited to cars, trucks, boats, and motorcycles. Additionally, the vehicle cover 12 may uniquely shaped and sized to conform type of vehicle 14 on which the vehicle cover 12 is used.

The vehicle cover 12 is configured to cover the vehicle 14 and protect the vehicle 14 from environmental conditions such as wind, dust, snow, ice and rain, and from physical conditions such as bird feces. The vehicle cover 12 has an added advantage of allowing for air flow between the vehicle cover 12 and the vehicle 14. The airflow around the vehicle 14 allows the vehicle 14 to not become overheated in extreme weather conditions. The ability for air to continue to flow around the vehicle 14 even while the vehicle cover 12 is in place unique benefit of using the vehicle cover 12 described herein.

In an embodiment, the vehicle cover 12 may be made from any pliable, and water-resistant material, including but not limited to at least one of UV resistant aluminum film, Polyethylene (PE) layer for water resistant and protection, Ethylene-Vinyl Acetate (EVA) for elasticity and protection, and soft liner (that comes in contact with vehicle exterior/paint. In an embodiment, the vehicle cover 12 includes a waterproof fabric that is configured to be exposed to the outer environment, and an inner soft layer that is contact with an outer surface of the vehicle 20.

In another embodiment, the vehicle cover 12 may be made from a multi-coated material having one or more coatings on a base fabric. The vehicle cover 12 may be made from a polyester fabric with first coating of polyurethane coating and a second coating of Silver Aluminum and Polyurethane. The base fabric may be coated using any conventional coating method.

The vehicle cover 12 having the multi-coated material, may also include an inner soft layer that is contact with an outer surface 20 (not shown) of the vehicle 14. The inner soft layer may be chosen from any soft material that will not scratch, erode, or alter the outer surface 20 of the vehicle 14. In an embodiment, the vehicle cover 12 is made of 190T polyester taffeta with PP cotton.

The vehicle cover 12 may be made of multi-layered fabric (not shown) that is customized according to varying sizes and shapes of the vehicle on which it will be placed. Multiple layers of fabric are adhered together and are configured to increase the durability, flexibility, and breathability of the vehicle cover 12. In some embodiments, the multi-layered textile includes at least two distinct layers. In other embodiments, the multi-layered textile includes more than two layers. In another embodiment, the multi-layered textile has six (6) layers. The layers of fabric are chosen for their durability, weather resistance and temperature resilient properties. In an embodiment, the multi-layered textile may include a UV-resistant aluminum film layer, a first snow proof and waterproof layer, a dustproof layer, a second snow proof and waterproof layer, a constant temperature layer and a thicker, soft liner.

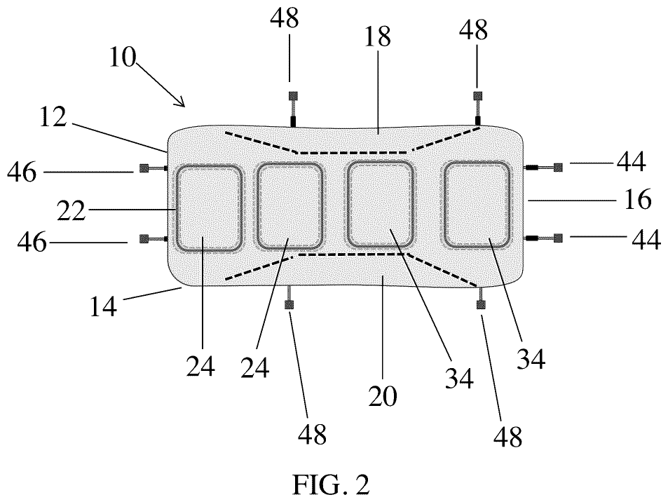

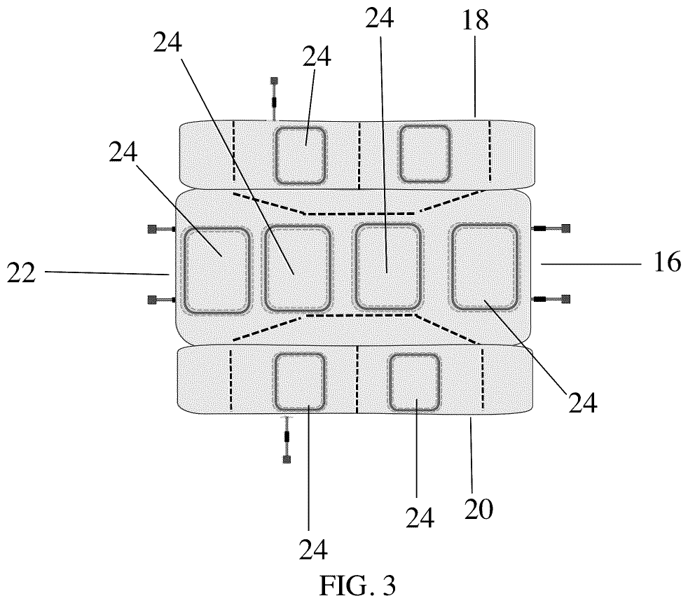

Referring again to FIGS. 1 and 2, the vehicle cover 12 may also include at least one panel 24 that is configured to provide shape to the vehicle cover 12. In an embodiment, the vehicle cover 12 includes at least three panels 24. In an embodiment, the vehicle cover 12 includes at least four panels 24. In another embodiment, the vehicle cover 12 includes six panels 24. Referring to FIG. 3, the vehicle cover 12 may include 8 panels 24. The panels 24 are configured to cover at least the front end 16, a top 26, and the back end 22 of the vehicle 14. The vehicle cover 12 is also configured to cover the first and second side 18, 20 of the vehicle 14.

The number, and placement, of panels 24 is chosen with consideration to the type of vehicle 14. For example, a motorcycle or bicycle cover may include two panels placed on a first and second side of the motorcycle cover. In another embodiment, an All-Terrain Vehicle (ATV) cover may include three panels that are placed along an outer top portion of the ATV.

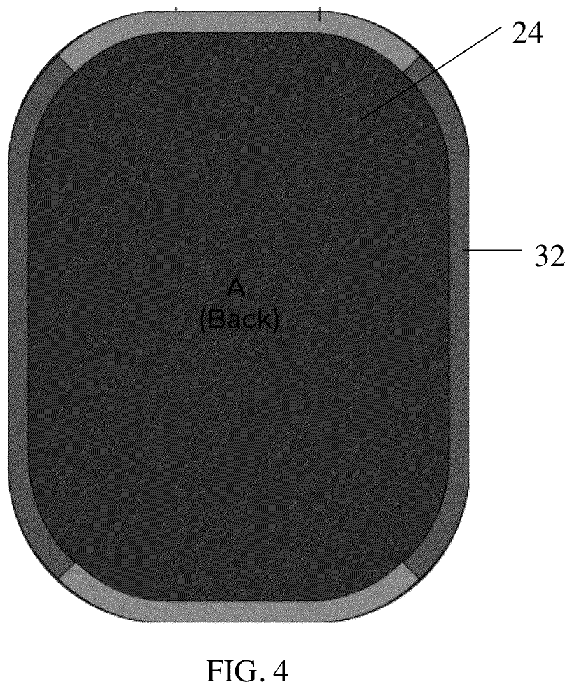

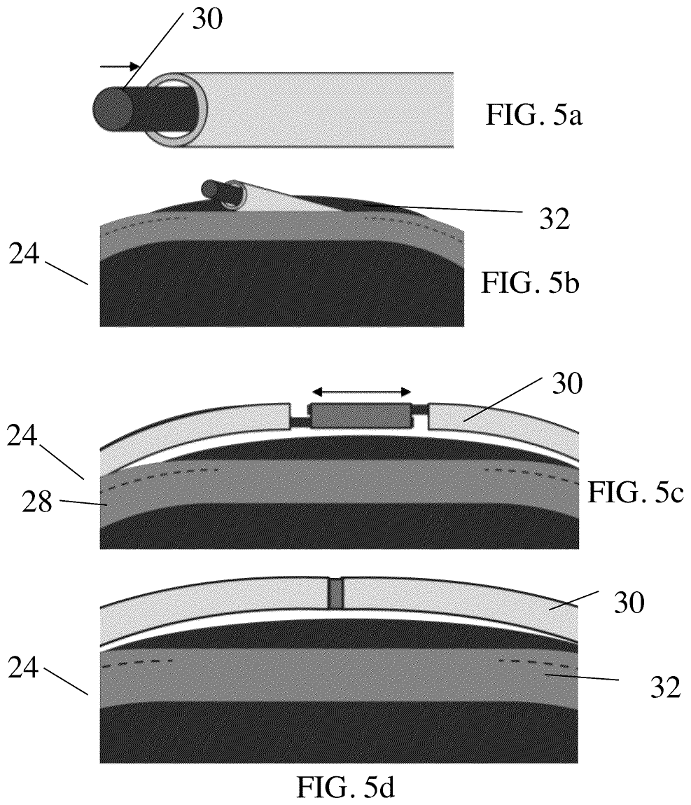

Referring to FIG. 4, each panel 24 includes a frame 28 that creates a size and shape of each panel 24. Referring to FIGS. 5a-5d, the frame 28 is created by stitching fabric from the vehicle cover 12 together to form a pocket 32 which is configured to receive the flexible rod 30. The frame 28 includes at least one flexible rod 30 that is attached to the frame 28 in order to provide structure to each panel. The flexible rods 30 are inserted into the pocket 32 of the frame 28 to create the panel 24. The frame 28 may comprise one long rod that is removably attached to the vehicle cover 12. Referring to FIG. 3, the frame 28 may comprise multiple smaller rods that are connected together to form a long rod. In one embodiment, the smaller rods may be removably attached to one another to create the frame 28.

The frame 28 may be created from the same fabric as the vehicle cover 12. The frame 28 may have a different size and shape depending on the placement of the panel 24 on the vehicle cover 12. To achieve the different sized frames 28, the flexible rod 30 may be any size necessary to create the frame 28 shape and size that is appropriate. For example, the flexible rod 30 may be shorter in length to create a smaller panel 24 in the back end 22 of the vehicle 14 and may be longer in length to create a larger panel 24 on the top 26 of the vehicle 14. In another example, the flexible rod 30 may be the same length for each panel 24 of the vehicle cover 12.

Referring again to FIG. 2, the plurality of panels 24 are attached one to another to form a series of sequential panels 24 throughout the vehicle cover 12 to enable the functionality of ‘unfolding’ the vehicle cover 12 in a timely and convenient matter. The plurality of panels 24 may be attached to one another using any conventional technique, including but not limited to stitching, and adhesive bonding. The panels 24 provide structure to the vehicle cover 12 and also allows for air flow between the vehicle cover 12 and the vehicle 14. This airflow is vital to keeping the inside of the car from being affected by extreme temperatures, particularly rising heat. The panels 24 provide structure and elevates the vehicle cover 12 from the outer surface of the vehicle 14. This allows for air to flow more freely and allows for reduction of temperature and ventilation to avoid condensation on the outer surface and within the vehicle 14 Preventing moisture and condensation from accumulating between the vehicle cover 12 and the vehicle 14 is important because excess moisture can cause the growth of mold, mildew and fungus.

Referring again to FIGS. 4 and 5, the flexible rods 30 may be made from any strong material, including but not limited to metal, steel, polymer. In an embodiment, the flexible rods 30 are made from a spring steel rod. The flexible rods 30 are coated with a protective film that coats the flexible rods. The protective film may be made of a polymer, including but not limited PVC.

In another embodiment, the flexible rods 30 comprise a spring steel rod housed within a pvc tube. The flexible rods 30 made of spring steel are inserted into a pvc tube. The flexible rods 30 comprising the spring steel and pvc tube, are inserted into the frame 28. The flexible rods 30 are sized and shaped to match the size and shape of the corresponding frame 28. The flexible rods 30, having a first end 34 and second end 36 that are removably connected by an electrical cable connected 38. The first end 34 of the flexible rod 30 is inserted into a first end 40 of the electrical cable connector 38. The second end 36 of the flexible rod 30 is inserting into the second end 42 of the electrical cable connector 38.

Referring again to FIGS. 2 and 3, the vehicle cover 12 may further include a rear elastic band 44 and a front elastic band 46 configured to secure the vehicle cover 12 to a vehicle 14. The rear elastic band 44 is secured to the vehicle cover 12 to the back end 22 of the vehicle 14. Similarly, the front elastic band 46 is secured to the vehicle cover 12 to the front end 16 of the vehicle 14. The rear elastic band 44 and the front elastic band 46 are attached to the vehicle cover by a triangular polymer buckle to allow even spread of force and elasticity of the bands. The rear elastic band 44 and the front elastic band 46 may be made of any stretchable material such as polyester and natural latex rubber. In an embodiment, the rear elastic band 44 and the front elastic band 46 are made of elastic webbing.

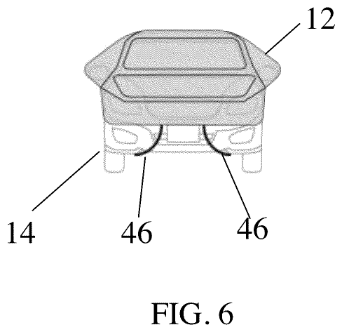

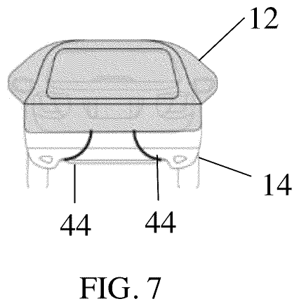

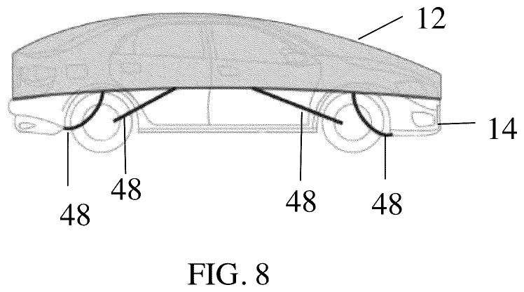

Referring to FIGS. 6-8, the vehicle cover 12 may include at least two front elastic bands 46 to secure the front side 16 of the vehicle 14. The vehicle cover 12 may also include at least two rear elastic bands 44 to secure the rear side 22 of the vehicle 14. The vehicle cover 12 may also include at least one side elastic band 48 to secure to the first and second sides 18, 20 of the vehicle 14. Each of the side bands 48 may include a plastic hook that secures the side bands 48 to a vehicle wheel. The elastic side bands 48 may be fixedly attached to the vehicle cover 12 or detachably attached to the vehicle cover 12.

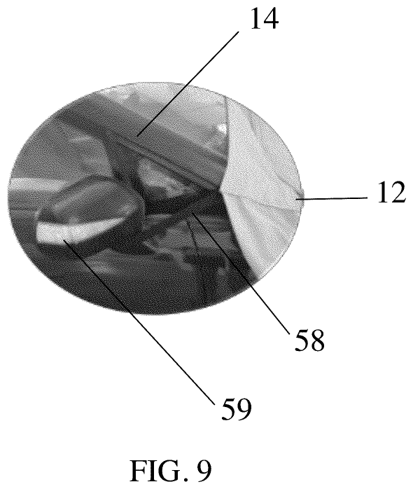

Referring to FIG. 9, the vehicle cover 12 may also include side mirror bands 58 that are configured to attach to one or more side mirrors 59 of the vehicle 14. This allows for a better and more secure fit to the vehicle 14.

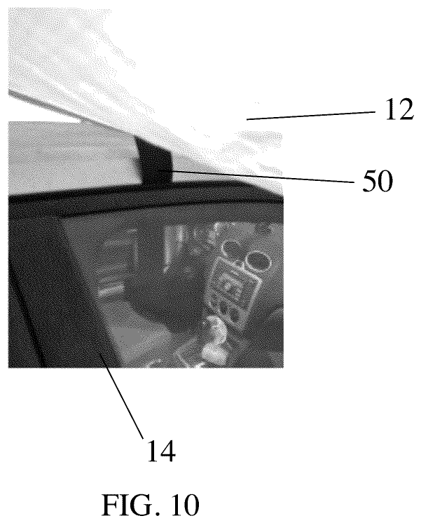

Referring to FIG. 10, an anti-theft anchor 50 may be fixedly attached or detachably attached to the vehicle cover 12. The anti-theft anchor 50 is intended to be placed inside of the vehicle 14 through a window to prevent unauthorized removal of the vehicle cover. The anti-theft anchor 50 may be made of any material, including but not limited to polyester and natural latex rubber. In an embodiment the anti-theft anchor 50 is made of elastic webbing.

The vehicle cover 12 may also include one or more reflective stripes 52 (not shown) placed on the vehicle cover 12. The one or more reflective stripes 52 are configured to illuminate the vehicle cover 12 at night. The one or more reflective stripes 52 may be made of any material, including but not limited to polyester and natural latex rubber.

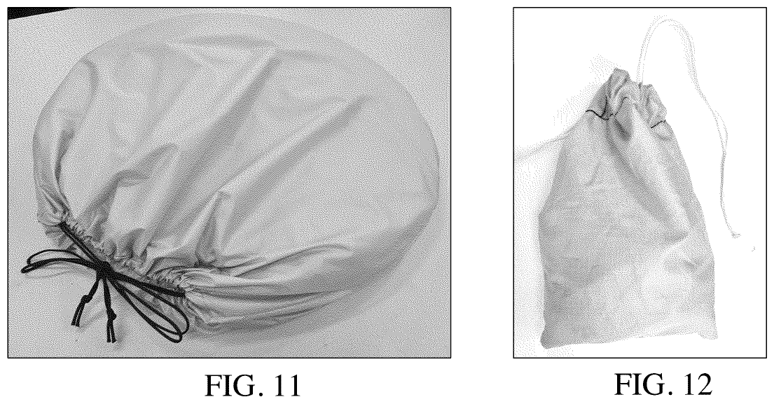

Referring to FIGS. 11-12, the vehicle cover assembly 10 includes a carrying bag 13 for housing the vehicle cover 12. The carrying bag 13 may be made of any material, including but not limited to UV resistant aluminum film, Polyethylene (PE) layer for water resistant and protection, and Ethylene-Vinyl Acetate (EVA) for elasticity and protection.

The carrying bag 13 may include an opening configured to receive the vehicle cover 12 when the vehicle cover 12 is not in use. The carrying bag 13 may further include a securing member 54 that allows the carrying bag 13 to be securely closed when the vehicle cover 12 is not in use. The securing member 54 may be a drawstring or an elastic band. The securing member 54 is further considered to allow the opening of the carrying bag 13 to be enlarged to size to receive the carrying bag 13 and then allow the opening of the carrying bag to be reduced in size to secure the vehicle cover within the carrying bag 13.

The vehicle cover assembly 10 may be manufactured using the following manufacturing process. The multi-layered textile is cut into pre-determined fabric shapes 56 (depending on type and size of vehicle). Graphics may be printed on the relevant pre-determined fabric shapes (e.g., sign of FRONT, branding elements). A ventilation opening (to allow release of moisture) may be cut in a front side and a rear side of the pre-determined fabric shapes.

The pre-determined fabric shapes 56 may be sewn together to form an exterior of the vehicle cover 12. The reflective stripes are sewn onto sides of the cover. An additional closed shape trim/tunnel (from same fabric as cover) may be added in pre-determined locations throughout the cover to create the frame 28 through which the flexible rods 28 are inserted. The location and dimensions of the closed frame 28 depends on the type of the vehicle 14 and size of the vehicle cover 12.

A number flexible rods 28 are sized and cut (number of rods and dimensions depends on size of the vehicle cover 12). In some embodiments, the flexible rods 28 may be one long rod having a length equivalent to the circumference of the corresponding panel 34. In other embodiments, the flexible rods 28 may comprise a plurality of individual rods that are attached in such a way that the total length is equivalent to the circumference of the panel 34. In these embodiments, the flexible rods 28 may be attached using any conventional method.

The flexible rods 28 are integrated into the cover 12, via the frame 28, providing the structure to create a series of panels 34. The flexible rods 28 are coated with a polymer (e.g., PVC), inserted into the above mentioned pocket 32 formed by the frame 28 forming a series of closed-shaped panels 24 having different shapes (such as rectangle, circle, ellipse) and sealed together on both ends by a metal/polymer clip. Upon insertion into the frame 28, the flexible rods 30 takes the shape and dimension of the panels 24 depends on type of vehicle cover 12.

Once completed, the panels 34 provide a semi-rigid structure for the vehicle cover 12. This allows for better fit around the vehicle and increased airflow between the vehicle and the vehicle cover. The flexible rods 30 may be removed by a user 64 (not shown) through a dedicated opening in the frame 28. Removing (and re-inserting) of the flexible rods 30 may enable washing the vehicle cover 12 in a common household washing machine.

Referring again to FIGS. 6-8, the front elastic bands may be attached to a bottom front hem of the vehicle cover 12. Referring to FIG. 6 rear and side elastic bands 44, 46 and 48 are sewn along a bottom hem of the vehicle cover 12 to enable a tight fit to the vehicle 14. The at least one side elastic bands 48 are sewn to the vehicle cover 12 to allow securing of the vehicle cover 12 to at least one vehicle wheel 63.

The vehicle cover 12 may include at least two polymer buckles 60. The at least two polymer buckles 60 may be affixed to the vehicle cover 12 (one at front end and one at a rear end of the vehicle cover 12) and the front, rear and side elastic bands 44, 46 and 48 are attached to each respect end of the vehicle cover 12 to secure the vehicle cover 12 to the front end 16 and the rear end 22 vehicle. The at least two polymer buckles 60 are affixed, one on each side of the vehicle cover 12, to allow attachment of additional side bands 48.

The plastic or polymer hook 62 is attached to one end of the elastic side bands 48 (intended for securing to a wheel 63) and polymer clips are attached to the other end (allowing attachment to the cover side buckle).

The carrying bag 13 is sewn together from a fabric similar to the vehicle cover 12. A securing member 54 is affixed to the carrying bag 13. In an embodiment, elastic ropes are sewn at the opening of the cover to allow closing the carrying bag 13.

Applying the Cover:

The vehicle cover assembly 10 allows for easy coverage of the vehicle 12 by the user 64. To apply the vehicle cover 12, the user 64 removes the vehicle cover 12 from the carrying bag 13. The vehicle cover 12 is in a collapsed configuration while stored within the carrying bag 13. In the collapsed configuration, the panels 34 are stacked on top of one another. The user 64 can move the vehicle cover 12 from the collapsed configuration to the enlarged configuration by slightly releasing grip and letting the vehicle cover 12 unfold, moving the panels 34 from a stacked position to an unstacked position (it will do so automatically due to tension of the flexible rods 28).

Referring again for FIG. 1, the user 64 can place the folded vehicle cover 12 (all panels 34 placed one on top of the other) on a top side 19 of the vehicle 14. For example, the user 64 may place the folded vehicle cover 12 on a hood 66 of the vehicle 14. The vehicle cover 12 can be unfolded placing the panels 34 over the hood 66, a front windshield 68, a roof 70, and a rear windshield 72, and a trunk 74 of the vehicle 14. Referring again to FIG. 9, the user 64 can secure the vehicle cover 12 to the vehicle mirrors 59 with the dedicated side mirror bands 58. The vehicle cover 12 can be secured to right and left sides of the front end 16 of the vehicle 14 (with at least two front elastic bands 46). The vehicle cover 12 can be secured to right and the left sides of the rear end 22 with at least two rear elastic bands 44. Another option is to attach the detachable side bands 48 to the wheels 63.

Removing the Cover:

The vehicle cover assembly 10 also allows for ease in removing the vehicle cover 12. To remove the vehicle cover 12 from the vehicle 14, remove the rear elastic bands 44 the rear end 22 of the vehicle 12. Detach the side bands 48 from the wheels 63, if they are applied. The vehicle cover 12 is moved from the enlarged configuration to the collapsed configuration by folding the panels 34 in a layered way from the trunk 74 onto the rear windshield 72, the roof 70, the front windshield 68, and lastly the hood 66. The user 64 may remove the side mirror bands 58 and remove the front elastic bands 46 from the front end 16 of the vehicle 14.

The user 64 holds the folded vehicle cover 12 (with all panels 34 placed one on top of the other) upright along outer edges 65 of the vehicle cover 12, cross hands into an X shape and lower hands (cover will fold into an 8 shape). The vehicle cover 12 will now be in the collapsed configuration, which is a multi-layer circular shape.

Once in the collapsed configuration, the vehicle cover 12 can be placed in the carrying bag 13 for storage or transporting.

The vehicle cover assembly 10 provides benefits for vehicle owners who wish to protect their vehicle. The benefits include protecting the exterior and interior from heat, sun and UV rays and reducing the temperature inside the vehicle by improving air flow around the vehicle.

The vehicle cover assembly 10 has the added benefit of protecting the vehicle 14 from bird droppings, tree sap, defoliation, dust, acid rain, rain, snow, ice, and pollution.

The flexible rods 28 within the panels 34 allow for easy and fast application, removal and storage of vehicle cover 12.

The shape and structure of vehicle cover 12 enables improved flow of air between the vehicle cover 12 and the vehicle 14 allowing for ventilation which ultimately reduces the temperature within the vehicle.

The front, rear, and side elastic straps 44, 46, and 48 allow convenient and effective securing of the vehicle cover 12 to front end 16, the rear end 22 and the first and second sides 18, 20 of the vehicle 14.

A plurality of ventilation openings in the vehicle cover 12 allow moisture to be released and prevent it from building up/accumulating.

The reflective stripes ensure visibility of the vehicle during night hours or in dark spaces.

The anti-theft anchor 50 prevents unauthorized removal of the vehicle cover 12.

The carrying bag 13 allows for convenient storage of the vehicle cover during transportation and/or storage.

Applications:

The vehicle cover assembly 10 can be designed to be used by various types of vehicles. The vehicle cover assembly 10 can be designed as either a full vehicle cover (covering all sides and height of the vehicle 14) or a half vehicle cover (covering top parts of the vehicle incl the hood, the roof and the trunk as well as sides down to bottom of windows).

The vehicle cover assembly 10 can be used to cover a variety of car types, including but not limited to compact sedans, mid-size sedans, full-size sedans, SUVs, pick-up trucks, vans/mini vans.

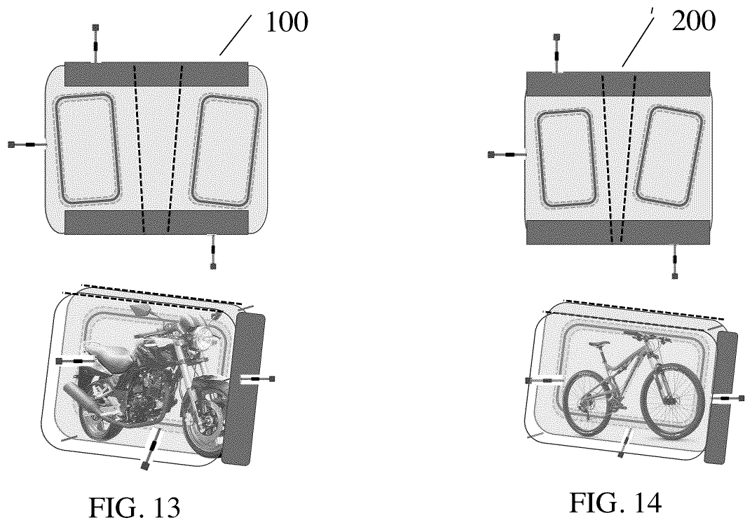

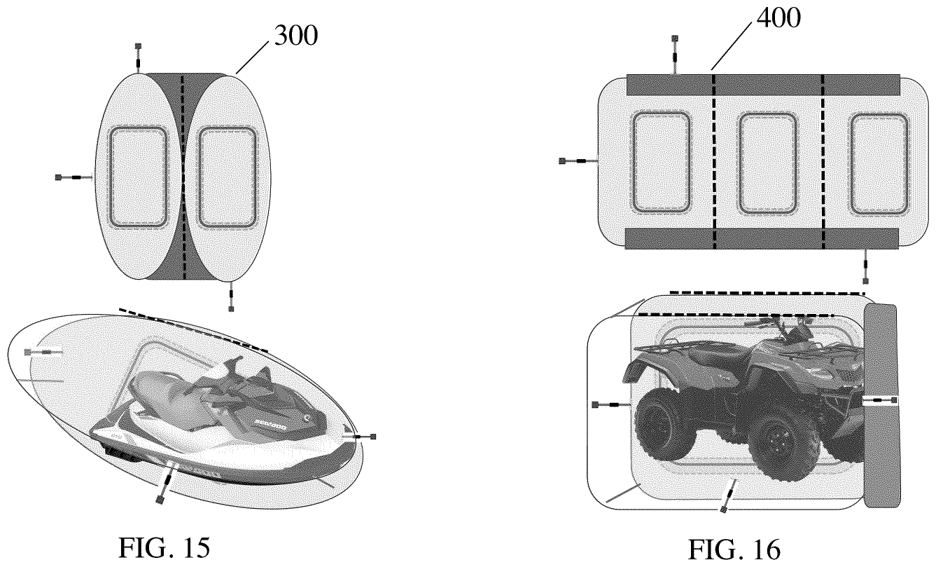

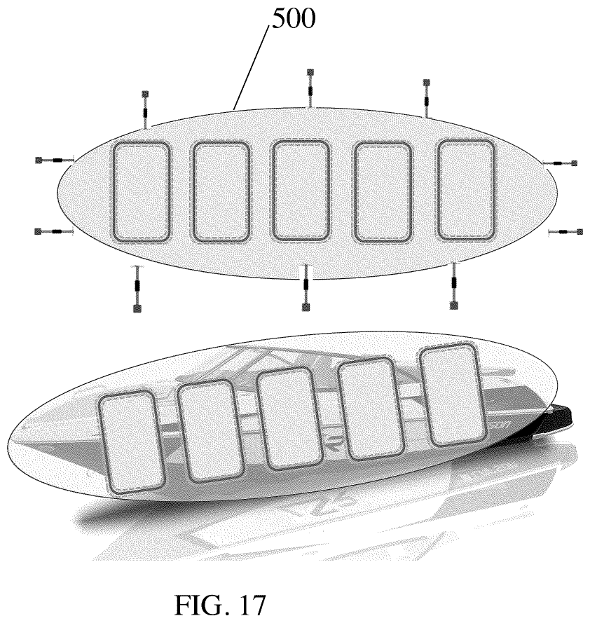

Referring to FIGS. 13-16, the vehicle cover assembly 100, 200, 300, 400 and 500 can also be used to cover a variety of motor, and non-motor, vehicles, including but not limited to Motorcycles (including scooters), Bicycles (including electric bicycles), Off Road Vehicles (ORVs)/Utility Task Vehicles (UTVs)/All-Terrain Vehicles (ATVs), Jet skis, Snow mobiles, Golf carts, and Boats.

1. A vehicle cover assembly comprising:
a vehicle cover having at least one panel, wherein the vehicle cover includes a multi-layered fabric, and wherein the at least one panel includes at least one flexible rod removably attached to the vehicle cover; and
a carrying bag.

2. The vehicle cover assembly of claim 1, wherein the multi-layered fabric comprises at least a UV resistant film layer, a polyethylene layer, an ethyl-vinyl acetate layer, and a soft-liner layer.

3. The vehicle cover assembly of claim 1, wherein the multi-layered fabric is 190T polyester taffeta fabric with PP cotton.

4. The vehicle cover assembly of claim 1, wherein the multi-layered fabric has 6 layers.

5. The vehicle cover assembly of claim 4, wherein the multi-layered fabric includes a UV resistant layer, a first snowproof and waterproof layer, a dustproof layer, a second snowproof and waterproof layer, a constant temperature layer, and a soft layer.

6. The vehicle cover assembly of claim 5, wherein the soft layer comes in contact with a vehicle exterior.

7. The vehicle cover assembly of claim 1, wherein the at least one flexible rod is made from metal, steel, or polymer.

8. The vehicle cover assembly of claim 6, wherein the at least one flexible rod is enclosed in a protective film or Polyvinyl chloride (PVC) tube.

9. The vehicle cover assembly of claim 7, wherein the at least one flexible rod is enclosed in a polyvinyl chloride (PVC) tube.

10. The vehicle cover assembly of claim 1, wherein the at least one panel has a frame around an outer edge of the at least one panel.

11. The vehicle cover assembly of claim 10, wherein the frame forms a pocket configured to receive the at least one flexible rod.

12. The vehicle cover assembly of claim 9, wherein the vehicle cover further comprises at least one elastic band attached to an outer edge of the vehicle cover.

13. The vehicle cover assembly of claim 12, wherein the vehicle cover further comprises a rear elastic band and a front elastic band.

14. A method of using the vehicle cover assembly of claim 13, the method comprising:
unfolding the vehicle cover;
placing the vehicle cover over a vehicle;
securing the vehicle cover to the vehicle by attaching the elastic band, the rear elastic band, and the front elastic band to the vehicle.

15. The vehicle cover assembly of claim 1, wherein the carrying bag is configured to house the vehicle cover.

16. A vehicle cover assembly comprising:
a vehicle cover having at least one panel, wherein the vehicle cover includes a multi-coated fabric, and wherein the at least one panel includes at least one flexible rod removably attached to the vehicle cover; and
a carrying bag.

17. The vehicle cover assembly of claim 16, wherein the multi-coated fabric has at least 4 coats.

18. The vehicle cover assembly of claim 17, wherein the multi-layered fabric includes a 190T polyester taffeta fabric having a UV resistant aluminum powder coating, a Polyurethane water resistant coating, a Polyacrylate protective coating and a soft coating.

19. The vehicle cover assembly of claim 18, wherein the soft layer comes in contact with an outer surface of the vehicle.

20. A method of using a vehicle cover assembly, the method comprising:
Providing a vehicle cover assembly, the vehicle cover assembly comprising:
a vehicle cover having at least one panel, wherein the at least one panel includes at least one flexible rod removably attached to the vehicle cover; and
a carrying bag;
unfolding the vehicle cover;
placing the vehicle cover over a vehicle; and
securing the vehicle cover to the vehicle by attaching a first and second side elastic band, a rear elastic band, and a front elastic band to the vehicle.
